(19) United States
(12) Patent Application Publication
(10) Pub. No.: US 2017/0328337 A1
(43) Pub. Date: Nov. 16, 2017

(54) IGNITION UNIT, IGNITION SYSTEM, AND INTERNAL COMBUSTION ENGINE

(71) Applicant: IMAGINEERING, Inc., Kobe-shi, Hyogo (JP)

(72) Inventors: Yuji Ikeda, Kobe-shi (JP); Minoru Makita, Kobe-shi (JP)

(73) Assignee: IMAGINEERING, Inc., Kobe-shi, Hyogo (JP)

(21) Appl. No.: 15/529,217

(22) PCT Filed: Nov. 24, 2015
(86) PCT No.: PCT/JP2015/082858

§ 371 Date: May 24, 2017

(30) Foreign Application Priority Data
Nov. 24, 2014 (JP) 2014-237242
Nov. 27, 2014 (JP) 2014-240648
Jun. 16, 2015 (JP) 2015-120831

(51) Int. Cl. F02P 23/04; F02P 3/01

(52) U.S. Cl. CPC F02P 23/045; F02P 3/01

(57) ABSTRACT

An ignition unit improves an air-fuel-ratio, i.e., good mileage and lean burn without changing a gasoline engine structure significantly. The ignition unit comprises a discharge device including a booster and a discharger provided at an output side of the booster, the booster having a resonance structure configured to boost the electromagnetic wave inputted from the electromagnetic wave oscillator so as to cause a discharge from the discharger, and an electromagnetic wave emitter electrically connected to the electromagnetic wave oscillator and configured to emit the electromagnetic wave inputted from the electromagnetic wave oscillator. Moreover, the ignition unit further includes a housing part including a first hole into which the discharge device is inserted and a second hole into which the electromagnetic wave emitter is inserted such that the housing part houses therein both the discharge device and the electromagnetic wave emitter, and the housing part can be inserted into a single hole of a cylinder head of an internal combustion engine.

### TECHNICAL FIELD

The present invention relates to an ignition unit that is used in an internal combustion engine, specifically, an ignition unit that ignites fuel by using microwaves. Moreover, the present invention also relates to an ignition system that uses the ignition unit.

### BACKGROUND ART

Ignition plugs such as spark plugs have been used conventionally in the internal combustion engine such as gasoline engine.

In these days, electric cars in that only electricity is used as motor power and gas fuel or liquid fuel is not used, and vehicles that use fuel such as natural gas in smaller CO₂ emission amount have been practically in use. However, cost for vehicle main body is high expensive compared to gasoline-powered vehicles, and infrastructures such as charging station and natural gas station are still insufficient. Due to the above factors, it is difficult to advance diffusion of such vehicles smoothly.

Accordingly, demand for gasoline-powered vehicles is still much high, and various technical developments for improving air-fuel-ratio, i.e., good mileage and lean burn in gasoline-powered vehicles are currently performed in popular.

Closely related to the above situation, the applicant suggests art of achieving air-fuel-ratio improvement by applying plasma technique to the internal combustion engine, and the development thereof has been advanced (for example, Patent Document 1).

### PRIOR ART DOCUMENT(S)

### Patent Document

Patent document 1: Japanese Patent Publication No. 4876217
Patent document 2: Japanese Patent Application No. 2013-171781

### SUMMARY OF INVENTION

### Problems to be Solved

Moreover, the applicant has developed new-type ignition plug that causes discharge by boosting the received microwave (Patent Document 2). Since the microwave is used as power source in this ignition plug, the discharge in high speed can continuously be caused. Therefore, non local thermodynamic equilibrium plasma can be generated in an arbitral timing. This cannot be achieved by conventional spark plug. By use of the new-type ignition plug, the air-fuel-ratio can be improved.

However, since the above ignition plug is designed to be smaller in size than the conventional spark plug due to adoption of resonance structure of microwave, plasma-generation-possible-range is reduced. Therefore, when the ignition plug is used for larger size engine and operation load is high and etc., there is a case where enough size of plasma cannot be generated.

The present invention is made in view of the above points.

### Measures for Carrying Out the Invention

An ignition unit of the present invention comprises a discharge device comprising a booster and a discharger provided at an output side of the booster, the booster having a resonance structure configured to boost an electromagnetic wave inputted from an electromagnetic wave oscillator so as to cause a discharge from the discharger, and an electromagnetic wave emitter configured to emit an electromagnetic wave inputted from the electromagnetic wave oscillator.

An ignition system of the present invention comprises an electromagnetic wave oscillator configured to oscillate and output an electromagnetic wave, a discharge device comprising a booster and a discharger provided at an output side of the booster, the booster having a resonance structure configured to boost the electromagnetic wave inputted from the electromagnetic wave oscillator so as to cause a discharge from the discharger, an electromagnetic wave emitter electrically connected to the electromagnetic wave oscillator and configured to emit the electromagnetic wave inputted from the electromagnetic wave oscillator, and a controller configured to control the discharge device and the electromagnetic wave emitter and to perform a first operation to ignite fuel in a combustion chamber by setting the electromagnetic wave emitter to off for output and setting the discharge device to on for output, and then perform a second operation to expand an ignited flame by setting the electromagnetic wave emitter to on for output.

### Effect of Invention

According to an ignition unit of the present invention, a discharge device is used that an electromagnetic wave such as microwave is used as power source, and therefore, non local thermodynamic equilibrium plasma can be generated in an arbitral timing, and an air-fuel-ratio, i.e., good mileage and lean burn, can be improved. Additionally, an electromagnetic wave emitter to assist an ignition and a combustion is used together. Therefore, enough strong plasma can be generated. Moreover, since the ignition unit of the present invention adopts a structure that a reduced-size ignition plug is incorporated with an antenna, the size thereof is a size insert-able into a cylinder head. Therefore, the ignition unit of the present invention can be utilized to the gasoline engine and etc. without changing engine shape or specification significantly.

### BRIEF EXPLANATION OF THE DRAWINGS

FIG. 1 illustrates a schematic block diagram of an ignition system regarding a first embodiment.

FIG. 2 illustrates a front view of a partial cross section of an ignition unit of the first embodiment.

FIG. 3 illustrates the front view of the partial cross section of a discharge device of the first embodiment.

FIG. 4 illustrates an equivalent circuit of the discharge device of the first embodiment.

FIG. 5 illustrates the front view of the partial cross section of the discharge device of the first embodiment.

FIG. 6 illustrates the front view of an antenna part of the discharge device of the first embodiment.

FIG. 7 illustrates the front view of the partial cross section of an ignition unit of a second embodiment.

FIG. 8 illustrates the front view of the partial cross section of an ignition unit of a third embodiment.

FIG. 9 illustrates the front view of the partial cross section of an ignition unit of a modification of the third embodiment.

FIG. 10 illustrates the front view of the partial cross section of an ignition unit of a fourth embodiment.

FIG. 11 illustrates the front view of the partial cross section of an ignition unit of a fifth embodiment.

FIG. 12 illustrates the front view of the partial cross section of an injector with a built-in ignition unit of a sixth embodiment.

FIG. 13 illustrates the front view of the partial cross section of an ignition system of one example of the first embodiment.

FIG. 14 illustrates a top surface of a piston of the ignition system of one example of the first embodiment.

FIG. 15 illustrates the front view of an antenna of one example of the first embodiment.

FIG. 16 illustrates the front view of the partial cross section of the ignition system of one example of the first embodiment.

FIG. 17 illustrates a bottom view of a cylinder head of the ignition system of one example of the first embodiment.

### DESCRIPTION OF THE PREFERRED EMBODIMENTS

In below, embodiments of the present invention are illustrated in details based on figures. Note that, following embodiments are essentially desirable examples, and the scope of the present invention, the application product, or the use does not intend to be limited.

### First Embodiment

### —Configuration of Ignition System 10—

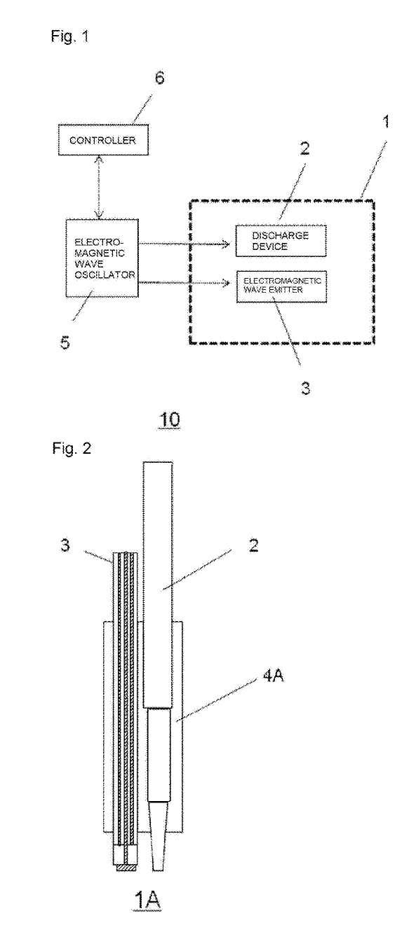

Referring to FIG. 1, an ignition system 10 of the present embodiment includes a discharge device 2, an electromagnetic wave emitter 3, an electromagnetic wave oscillator 5 configured to supply microwaves to these, and a controller 6 configured to control the electromagnetic wave oscillator 5. The discharge device 2 as described later in details is one kind of spark plug that was developed by the applicant. The electromagnetic wave emitter 3 emits an electromagnetic wave. In the present embodiment, the electromagnetic wave emitter is described as a device for emitting microwaves, however, the electromagnetic wave emitter may emit an electromagnetic wave belonging to other frequency band.

As illustrated in FIG. 2, the discharge device 2 and the electromagnetic wave emitter 3 are housed in a casing 4, and they constitute an integrally included ignition unit 1A. With regard to the ignition unit 1A, the casing 4 can entirely be inserted into a mounting port of the cylinder head. Specifically, it is assumed that the ignition unit 1A of the present embodiment replaces to the spark plug widely spreadly used in gasoline engine. Therefore, the ignition unit 1A has a size insert-able into so called M12 plug hole. That is, a diameter of the discharge device 2 is about 5 mm, and the diameter of the electromagnetic wave emitter 3 is also about 5 mm. The casing 4 includes two ports for inserting the discharge device 2 and the electromagnetic wave emitter 3 respectively into, and shapes of respective ports are designed such that tip ends of the discharge device 2 and the electromagnetic wave emitter 3 protrude into the engine combustion chamber. Moreover, if a heat release performance of the discharge device 2 and the electromagnetic wave emitter 3 is put priority onto, a metal with high thermal conductivity may preferably be adopted as the material of the casing 4. On the other hand, if an insulation performance between the discharge device 2 and the electromagnetic wave emitter 3 is put priority onto, an insulator such as ceramics may preferably be adopted. Nonetheless to say, a material having high thermal resistance performance should be adopted for use, because it is used for engine.

Note that, the ignition unit 1A may be used for not only reciprocating engine but also rotary engine. When the ignition unit 1A is used for rotary engine, if the tip parts of the discharge device 2 and the electromagnetic wave emitter 3 are in condition of protruding into the combustion chamber, it is dangerous because the rotor contacts with the tip parts. Therefore, the discharge device 2 and the electromagnetic wave emitter 3 should be constituted such that the tip parts do not protrude into the combustion chamber.

The discharge device 2 is also called as “Microwave Discharge Igniter (“MDI”: Registered Trademark).” It is constituted that 2.45 GHz band microwaves received from outside (electromagnetic wave oscillator 5) resonate, microwaves are boosted by resonation, the tip part (discharger) becomes high in voltage, and as a result, the discharge is caused. In this regard, the discharge device 2 largely differs from the normal spark plug.

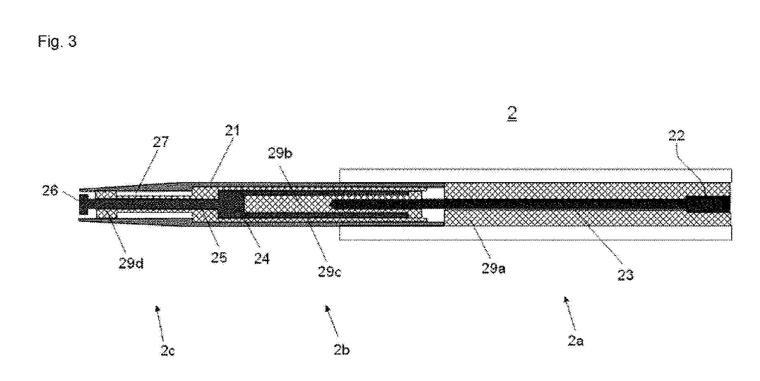

Referring to FIG. 3, the structure of the discharge device 2 is described in details. The discharge device 2 includes an input part 2a configured to input an microwave, a coupling part 2b configured to attain an impedance matching between the electromagnetic wave oscillator 5 designed at normally 50Ω system or a coaxial cable configured to transmit the microwave and the resonance structural part of the discharge device 2, and an amplifying part 2c configured to amplify voltage of microwave that is resonated by the microwave resonance structure. Moreover, the amplifying part 2c has a discharge electrode 26 at the distal end thereof. The respective parts inside of the discharge device 2 are housed by a cylindrical casing 21 that is made of metal with the electric conductivity.

The input part 2a comprises an input terminal 22 configured to receive microwave that is generated at the electromagnetic wave oscillator 5, and a first center electrode 23. The first center electrode 23 transmits microwave. A dielectric 29a is provided between the first center electrode 23 and the casing 21. The dielectric 29a is made of ceramic materials, for example.

The coupling part 2b includes the first center electrode 23 and a second center electrode 24. The coupling part 2b is provided to attain the impedance matching as described as above. The second center electrode 24 has a cylindrical structure that includes a bottom part at the amplifying part 2c side, and the cylindrical part surrounds the first center electrode 23. The stick-type first center electrode 23 and an inner wall of the cylindrical second center electrode 24 face from each other, and the microwave is transmitted from the first center electrode 23 to the second center electrode 24 by capacity-coupling at the facing part. In the cylindrical part of the second center electrode 24, a dielectric 29b such as ceramics is filled with, and a dielectric 29c such as ceramics is also provided between the second center electrode 24 and the casing 21.

The amplifying part 2c is provided with a third center electrode 25. The third center electrode 25 is connected to the second center electrode 24, and the microwave is transmitted from the second center electrode 24 to the third center electrode 25. A discharge electrode 26 is installed at a distal end of the third center electrode 25. Between the third center electrode 25 and the casing 21, a dielectric 29d such as ceramics is filled with. As explained as below, a cavity part 27 in which the dielectric 29d is not filled with is provided between the third center electrode 25 and the casing 21 in order to adjust the discharge capacity C3. The third center electrode 25 includes a coil element, and potential in microwave becomes in high as the microwave passes through the third center electrode 25. As the result, several tens KV of high voltage occur between the discharge electrode 26 and the casing 21, and the discharge is caused between the discharge electrode 26 and the casing 21. Moreover, the third center electrode 25 length is set to about ¼ wavelength of microwave. Here, the ¼ wavelength of microwave is the length that is taken into consideration of, for example, refractive index of the center electrode, and the ¼ wavelength of microwave does not indicate directly the ¼ wavelength of microwave exactly as stated. On top of that, if adjustment/design is performed such that a node of microwave is positioned at a boundary between the third center electrode 25 and the second center electrode 24 as an example, an anti-node of microwave becomes positioned at the distal end of the third center electrode 25 at which the discharge electrode 26 exists. Thereby, the voltage at the point can make larger and higher. Of course, in fact, there are various factors, and such design is not always preferable. However, the design is performed based on such concept in the present embodiment.

An annular circular space is formed between the discharge electrode 26 and the casing 27, and discharge is caused in this space. That is, discharge is performed in any direction. This point differs from the spark plug that performs so called “one-point-discharge” between the discharge electrode and the ground electrode.

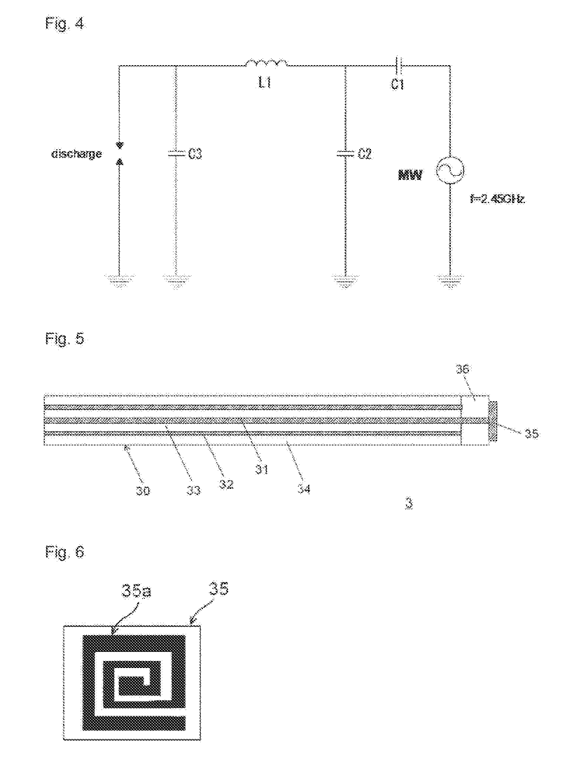

FIG. 4 is a figure illustrating an equivalent circuit of the discharge device 2. The microwave received from an outside oscillation circuit (MW) having voltage V1, frequency 2.45 GHz, is connected to the resonance circuit that is constituted of capacity C3, reactance L, and capacity C2 via capacity C1. Moreover, the discharger is provided in parallel with the capacity C3.

Here, C1 corresponds to a coupling capacity, and C1 is determined mainly by positional relation between the second center electrode 24 and the first center electrode 23 (distance between both the electrodes and area of mutually facing part) and material filled with between both the electrodes, in the present example, ceramic structural dielectric 29b. The first center electrode 23 may be constituted movably in the center axis direction so as to attain easily impedance adjustment.

The capacity C2 is a grounding capacity that is formed by the second center electrode 24 and the casing 21. C2 is determined by the distance between the second center electrode 24 and the casing 21, the mutually facing area, and the relative permittivity of the dielectric 29c. The casing 21 is formed of metal with electric conductivity and functions as the ground electrode. Reactance L corresponds to a coil element of the third center electrode 25.

The capacity C3 is a discharge capacity that is formed by the third center electrode 25, the discharge electrode 26, and the casing 21. This is determined by such as (1) shape of the discharge electrode 26, size thereof, and distance to/from the casing 21, (2) distance between the third center electrode 25 and the casing 21, and (3) cavity space (air layer) 27 that is provided between the third center electrode 25 and the casing 21 and thickness of the dielectric 29d. If C2>>C3, the potential difference between both the ends of the capacity C3 can sufficiently become larger than V1. As the result, the discharge electrode 26 can become potential in high. Moreover, since C3 can make smaller, the condenser area can be reduced. Note that, the capacity C3 is substantially defined by the mutually facing part of the third center electrode 25 and the casing 21 that sandwitchs the dielectric 29d. To put it the other way around, the cavity space (air layer) 27 is changed of length in the axial direction, and thereby, the capacity C3 can also be adjusted.

In a case where the coupling capacity C1 is deemed to be sufficiently small, the capacity C3, reactance L, and the capacity C2, constitute a series resonance circuit, and the resonance frequency f is expressed in below mathematical formula 1.

$$f = \frac{1}{2 π \sqrt{LC}} \qquad ( formula 1 )$$

where

$$\frac{1}{C} = \frac{1}{{C}_{3}} + \frac{1}{{C}_{3}}$$

That is, the discharge device 2 is designed such that if f=2.45 GHz, the discharge capacity C3, the coil reactance L, and the grounding capacity C2 satisfy the relation of the mathematical formula 1.

As described as above, the discharge device 2, by boosting system of the resonator, generates voltage Vc3 higher than power source voltage, i.e. voltage V1 of microwave inputted into the discharge device 2. Thereby, discharge is caused between the discharge electrode 26 and the ground electrode (casing 21). When the discharge voltage exceeds the breakdown voltage of gas molecules existed in the vicinity thereof, electrons are released from the gas molecules, and non local thermodynamic equilibrium plasma is generated to eventually ignite fuel.

Furthermore, since the 2.45 GHz band frequency is used, the condenser capacity can be made smaller, and the discharge device 2 is advantageous in size reduction. Since the discharge device 2 is made in reduced size, the size can become similar with the conventional spark plug if the discharge device 2 is combined with the electromagnetic wave emitter 3 described in below. Moreover, as the result of adopting the boosting system, the vicinity of the discharge electrode 26 of entire the discharge device 2 only becomes potential in high. Therefore, great advance is being made in isolation.

Additionally, the discharge device 2 is driven by microwave, and therefore, the discharge device 2 can freely be controlled intermittently through controlling the electromagnetic wave oscillator 5 by the controller 6 (referring to FIG. 1). That is, the control of the timing of microwave generation by the electromagnetic wave oscillator 5 leads to freely control of the discharge timing of the discharge device 2. In the normal spark plug that uses ignition coil with large reactance, it is difficult to respond high in speed and it is difficult to cause discharge in continuous. On the other hand, since the discharge device 2 is driven by microwave, it can respond high in speed. By controlling the electromagnetic wave oscillator 5 freely, discharge in almost continuous of the high frequency can be caused in an arbitral timing. Accordingly, various control can be performed.

As above, the discharge device 2 of the present embodiment largely differs from the conventional spark plug.

Next, referring to FIG. 5, the electromagnetic wave emitter 3 is largely divided into an antenna part 35 configured to emit the microwave into the combustion chamber and a transmission line 30 configured to transmit the microwave from the electromagnetic wave oscillator 5 to the antenna part 35.

Moreover, the electromagnetic wave emitter 3 includes a power supply unit (not illustrated in FIG. 5) configured to supply microwave from the transmission line 30 to the antenna part 35. The transmission line 30 can also be configured to be attachable and detachable with regard to the power supply unit. Note that, the transmission line 30 is constituted as a coaxial structure, and the transmission line 30 includes a center conductor 31 configured to transmit the microwave. Further, the transmission line 30 is provided with an outer conductor 32 configured to function as a ground and to prevent the microwave from leaking to outside. An insulator such as ceramics is filled with between the center conductor 31 and the outer conductor 32. An insulator made of elastic member, for example, covers the outside of the outer conductor 32.

As illustrated in FIG. 6 for example, the antenna part 35 can be formed by, for example, printing a metal pattern 35a in a spiral manner on a ceramic substrate.

The electromagnetic wave emitter 3 of the present embodiment is merely one example. If the electromagnetic wave emitter 3 is a device that can emit the microwave into the combustion chamber, it is not limited to the above embodiment version.

—Ignition System 10 Operation Example—

Next, an ignition system 10 operation example is described. Generally, first, the controller 6 controls the electromagnetic wave oscillator 5 such that the microwave is supplied only to the discharge device 2 from the electromagnetic wave oscillator 5. For example, the electromagnetic wave oscillator 5 is configured to output the electromagnetic wave from two channels, one channel A is connected to the discharge device 2, and another channel B is connected to the electromagnetic wave emitter 3. That is, the controller 6 firstly performs a control to only the channel A, while it controls the channel B such that the output becomes “off”. Then, if fuel in the combustion chamber is ignited by discharge of the discharge device 2, secondly the controller 6 controls the output of the channel B of the electromagnetic wave oscillator 5 to be “on” so as to expand flame, and the microwave is emitted from the channel B of the electromagnetic wave emitter 3. Thereby, the flame is expanded.

Moreover, it is considerable, as a second example, to switch use/non-use of the electromagnetic wave emitter 3 according to an operation condition. For example, during a first operation condition at a low load is detected, the ignition is performed only by discharge by the discharge device 2. During a second operation condition at a high load is detected, the ignition is performed by the discharge device 2, and then, the flame can also be expanded by using the electromagnetic wave emitter 3.

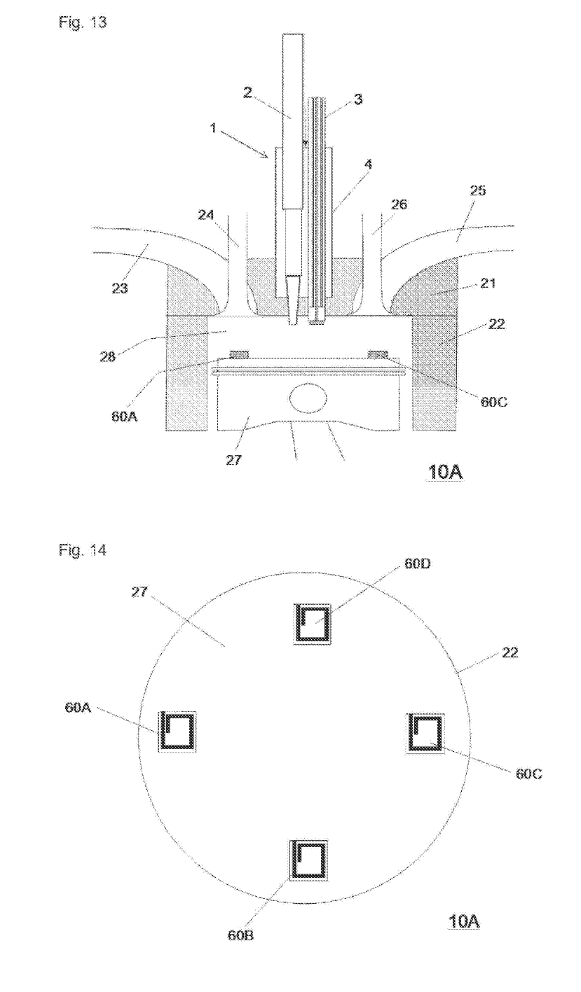

As a third example, antennas 60 (60A to 60D) may be positioned on a top surface of a piston 27 as illustrated in FIG. 13 and FIG. 14. These antennas 60 are positioned at an outer circumferential side of the piston 27, and microwaves emitted from the electromagnetic wave emitter 3 are received by the antennas. In other words, the antennas 60 function as so called “secondary antennas” that induce microwaves emitted radially from the electromagnetic wave emitter 3. That is, microwaves emitted from the electromagnetic wave emitter 3 are more efficiently induced to outer circumferential side of the combustion chamber by antennas 60. Thereby, flame ignited by the discharge device 2 can efficiently be expanded. Moreover, unburned gas occurrence at the outer circumference of the combustion chamber can be prevented.

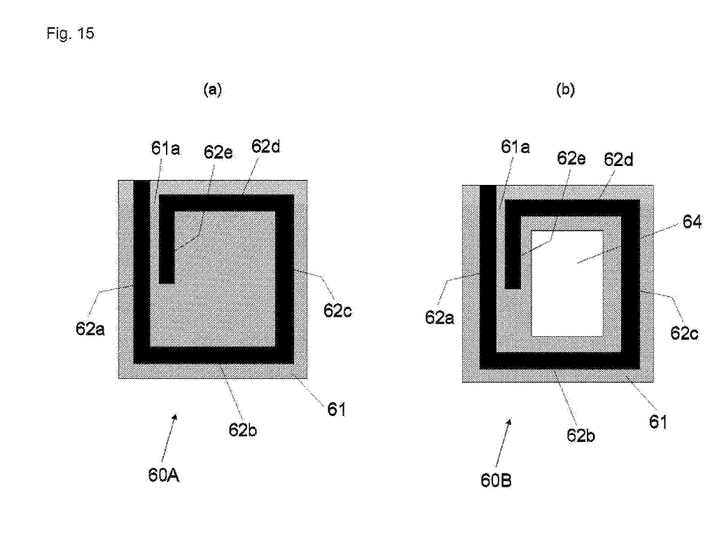

FIG. 15(a) is an antenna 60 configuration example. As illustrated in the figure, in the antenna 60, a conductor 62 is formed on a rectangular substrate 61 that is made of ceramic material. In order that an antenna sensitivity makes highest, the conductor 62 length is about ¼ wavelength of the microwave.

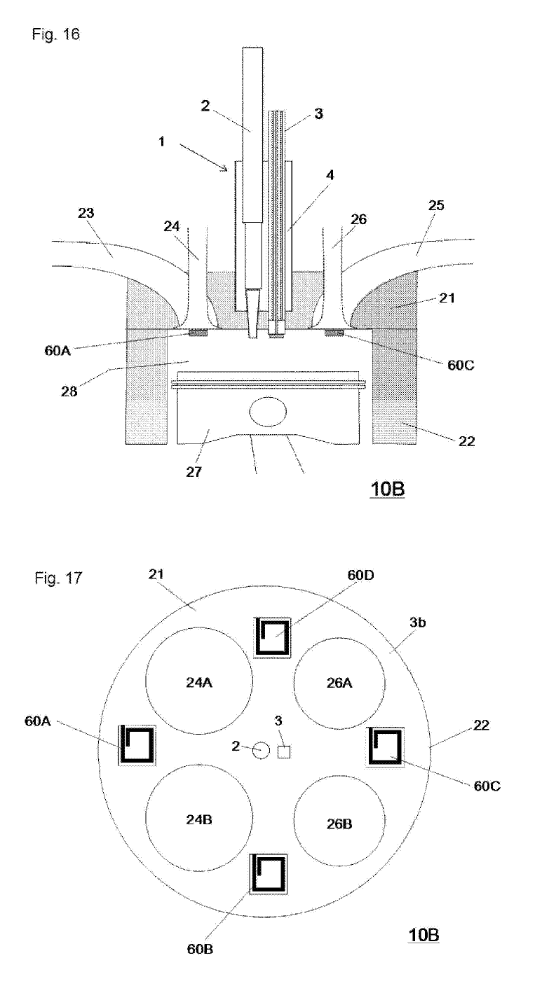

As a fourth example, as illustrated in FIGS. 16 and 17, antennas 60 (60A to 60D) may be arranged on the bottom surface of the cylinder head 21, i.e., between intake valves 24, between exhaust valves 26, or between intake valve 24 and exhaust valve 26. Even if such arrangement is performed, microwave emitted from the electromagnetic wave emitter 3 can be induced to the outer circumferential side of the combustion chamber, and unburned gas occurrence at the outer circumference can also be prevented.

Moreover, antennas 60 may be positioned in an array manner on the top surface of the piston. Thereby, even if a part of these antennas do not operate well by soot adhesion or heat damage, by operating remained antennas properly, microwaves emitted from the electromagnetic wave emitter 3 can be induced to the outer circumference of the combustion chamber.

### Second Embodiment

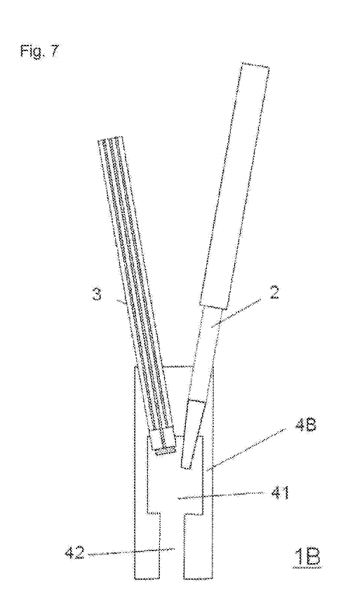

As illustrated in FIG. 7, the discharge device 2 and the electromagnetic wave emitter 3 may respectively be inclined to be positioned. By such arrangement, microwave emitted from the electromagnetic wave emitter 3 is easily to be irradiated to the tip part of the discharge device 2.

As the result of inclination, tip parts cannot respectively be protruded into the combustion chamber. Accordingly, in the present embodiment, a cavity 41 and a passage 42 configured to connect the cavity 41 to the combustion chamber are provided inside the casing 4B.

A weak spark ignited by the discharge device 2 is enhanced or strengthened by using the microwave emitted from the electromagnetic wave emitter 3. Thereby, the cavity 41 inside becomes high in pressure, and the flame is pushed forward to the combustion chamber via the passage 42.

In a case where the plug hole diameter size is sufficiently large, even if the discharge device 2 and the electromagnetic wave emitter 3 are respectively inclined to be arranged, the tip parts of them can be protruded into the combustion chamber. Accordingly, such cavity 41 and passage 42 are not required to be provided.

### Third Embodiment

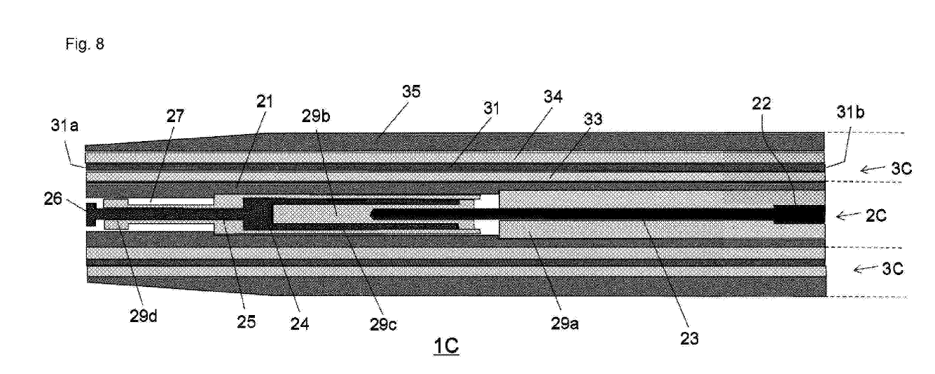

As illustrated in FIG. 8, the ignition unit 1C of the present embodiment is constituted by integrally including the discharge device 2 and the electromagnetic wave emitter 3 together. The ignition unit 1C is configured to form the electromagnetic wave emitter 3C cylindrically on the outer circumference of the discharge device 2C.

Here, with regard to the structure of the discharge device 2C, the casing 21 shape differs from the discharge device 2 of the first embodiment. However, similar configuration to the first embodiment is adopted regarding other parts.

On the other hand, the electromagnetic wave emitter 3C comprises an insulating tube 33, an induction tube 31, an insulating tube 34, and a conductive tube 35. The insulating tube 33 encompasses outer circumference of the conductor, casing 21. The insulating tube 33 is made of, for example, ceramics based on alumina (AL₂O₃) with high insulation performance and heat-corrosion-resistance-performance. The induction tube 31 is provided to encompass the insulating tube 33. The induction tube 31 transmits microwave to a front end part 31a from the electromagnetic wave oscillator 5 that is inputted from a rear end part 31b, and the microwave is emitted from the front end part 31a toward the combustion chamber. The induction tube 31 is made of the conductor such as metal. Note that, the vicinity of the front end part 31a may be made of material such as alumina with high insulation performance and high heat resistance performance. The insulating tube 34 is provided so as to surround a periphery of the induction tube 31, and the insulating tube 34 is made of material with high insulation performance and high heat resistance performance as well as the insulating tube 33. Moreover, the conductive tube 35 is provided at a periphery of the insulating tube 34. The conductive tube 35 prevents the microwave that propagates on the induction tube 31 from leaking to outside of the electromagnetic wave emitter 3C, and it is provided so as to secure safety and transmission efficiency.

According to the ignition unit 1C, the discharge device 2 and the electromagnetic wave emitter 3 are integrally included together in a coaxial manner. Therefore, much size reduction can be achieved. As one example, the applicant succeeded in manufacturing a trial piece of the discharge device 2 having around 5 mm in diameter. Accordingly, the diameter of the ignition unit 1C in that the cylindrical emitter 3C is mounted on the outer circumference of the discharge device 2 can sufficiently make around 10 mm. Therefore, such ignition unit 1C can be inserted into the mounting port of the spark plug of, for example, gasoline engine without any change. The ignition unit 1C can be used without changing engine shape or specification significantly.

### Modification Example

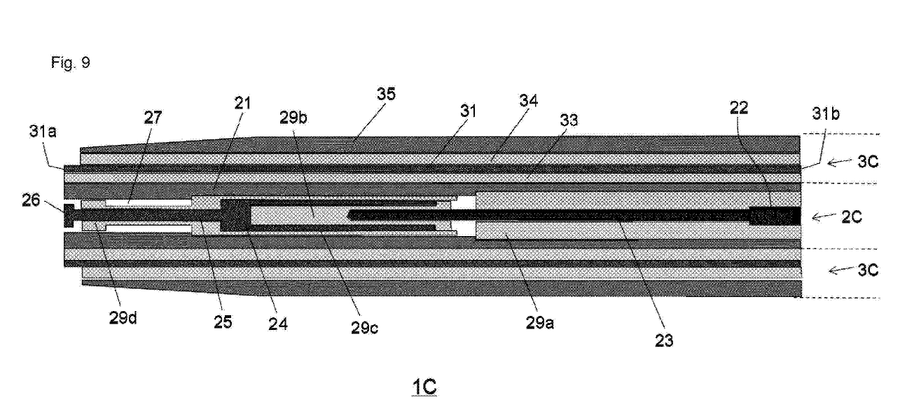

FIG. 9 is a modification of the ignition unit 1C regarding the third embodiment. The outer circumferential side of the tip part of the induction tube 31 may be configured so as not to be covered by the insulating tube 34 and the conductive tube 35. Thereby, the microwave can more efficiently be emitted from the tip part of the induction tube 31.

### Fourth Embodiment

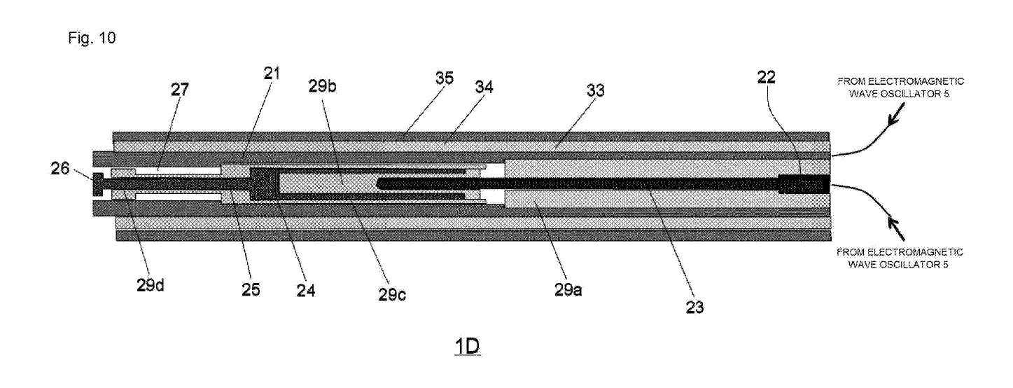

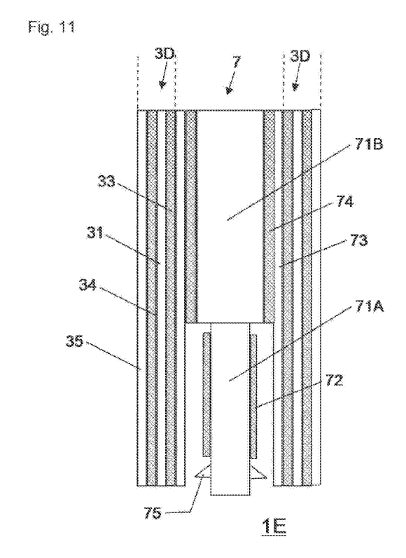

As illustrated in FIG. 10, the ignition unit 1D regarding the present embodiment is formed to include integrally the discharge device and the electromagnetic wave emitter together as well as the third embodiment. Note that, the configuration thereof differs from the third embodiment in that the ignition unit 1D has a structure of propagating microwave on the surface of outer circumference of the casing 21 of the discharge device 2, i.e., at the insulating tube 33 side. That is, the casing 21 also serves as the insulating tube 33 of the third embodiment.

According to this configuration, a diameter-size-reduction of the ignition unit can be achieved, compared to the third embodiment.

### Fifth Embodiment

As illustrated in FIG. 11, the ignition unit 1E regarding the present embodiment is also configured to include integrally the discharge device and the electromagnetic wave emitter together as well as the third embodiment and the fourth embodiment. However, the structure of the discharge device differs from other embodiments.

A discharge device 7 of the present embodiment comprises a center electrode 71, a dielectric 72, a ground electrode 73, a discharge electrode 75 and etc. The center electrode 71 is divided into a first part 71A positioned at the distal end and a second part 71B positioned at rear position thereof. The center electrode 71 is made of conductor such as metal, and the electromagnetic wave propagates on the surface thereof. The dielectric 72 made of ceramics based on alumina (AL₂O₃) and etc., is formed on the surface of the first part 71A. A projected discharge electrode 75 is formed at the distal end of the first part 71A. The cylindrical ground electrode 73 is provided with a space around the first part 71A and the dielectric 72.

The discharge device 7 includes a resonance structure such that the center electrode 71, the dielectric 72, and the ground electrode 73 resonate at a microwave frequency. Thereby, the boosting by the resonance structure leads to make the entered microwave voltage highest at the vicinity of the discharge electrode 75. As a result, discharge can be caused between the discharge electrode 75 and the ground electrode 73. Thereby, non local thermodynamic equilibrium plasma can be generated at the tip part of the discharge device as well as the discharge device 2 of the ignition unit 1A of the first embodiment, and fuel can be ignited.

Further, as well as the first embodiment, since the discharge device 7 is driven by the microwave, the discharge in high speed can continuously be caused in an arbitral timing, and plasma can be generated in an arbitral size.

The electromagnetic wave emitter 3D configured to emit the microwave is formed at a periphery of the discharge device 7. The structure of the electromagnetic wave emitter 3D is similar with the electromagnetic wave emitter 3C of the third embodiment.

Therefore, firstly after the fuel is ignited by the discharge device 7, the microwave is emitted from the electromagnetic wave emitter 3 in the case of the ignition unit 1E. Thereby, the flame ignited can be expanded also with the ignition unit 1E.

Moreover, the ignition unit 1E can also be designed in diameter about 10 mm as well as the ignition unit 1C of the third embodiment, and therefore, it can be inserted into the mounting port of the spark plug of, for example, the gasoline engine without any change.

### Sixth Embodiment

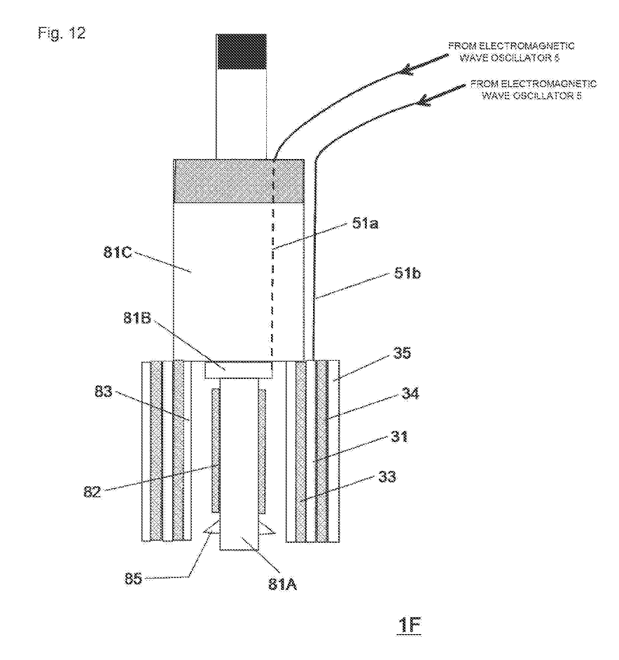

The present invention also applies to an injector 1F with a built-in ignition unit as illustrated in FIG. 12. The injector 1F with the built-in ignition unit replaces the center electrode 71 of the ignition unit 1E of the fifth embodiment to an injector main body. That is, the microwave resonation structure is formed by providing a dielectric 82 on the surface of a fuel injection pipe, and the microwave voltage is amplified. By providing a projected discharge electrode 85 on the distal end of the fuel injection pipe and causing a discharge between the discharge electrode 85 and the ground electrode 83, fuel injected from the fuel injection pipe is ignited.

On the other hand, the structure of the electromagnetic wave emitter 3 is substantially similar with the third and the fourth embodiments. The microwave transmitted from the electromagnetic wave oscillator 5 is temporally or tentatively transmitted to a center part 81B of the fuel injection pipe via a coaxial cable 51a. The center part 81B includes an impedance matching circuit (not illustrated). The impedance matching circuit attains an impedance matching between the coaxial cable (normally, 50Ω system) and the microwave resonance structural part. As one example, the coaxial cable 51a is inserted into a penetration hole that is provided inside the injector main body.

Moreover, the microwave transmitted from the electromagnetic wave oscillator 5 is entered into the induction tube 34 via a coaxial cable 51b. Thereby, the microwave is emitted from the distal end of the induction tube 34. The effect similar with the above respective embodiments can be achieved also by the present embodiment.

In these days, the diesel engine in which engine is motored by natural gas such as CNG has been developed. However, CNG has an ignition temperature higher than that of diesel oil, and therefore, ignition means that forcibly ignites is required if the compression ratio of the diesel engine is significantly not changed. Since the injector 1F with the built-in the ignition unit is constituted in size insert-able into the mounting port of the diesel engine injector, it is specifically suitable for an application in motoring the diesel engine by natural gas.

As above, the embodiments of the present invention are explained. The scope of the present invention is absolutely defined based on inventions described in the claims, and should not be limited to the above embodiments.

For example, the discharge device 2 is not limited to the above described version. For example, other types such as corona discharge plug (for example, “EcoFlash”, US Registered Trademark, manufactured by BorgWarner Inc.) may be used. However, igniter that is continuously dischargeable at high frequency is preferably chosen in order to obtain the effect described in the above embodiments.

The discharge device 2 is configured to motor by the microwave, and the electromagnetic wave emitter 3 is configured to emit the microwave, but they may be motored or emit in the electromagnetic wave having other band area.

Moreover, the discharge device 2 and the electromagnetic wave emitter 3 are integrally included together in the casing 4. However, they may be provided separately.

In a case where the voltage inputted from the electromagnetic wave oscillator 5 is low, voltage at the discharge electrode 26 of the discharge device 2 does not become in high sufficiently, and as the result, there is a case where discharge between the discharge electrode 26 and the casing 21 may not be caused. At that time, the discharge electrode 26 may emit the microwave. By considering this situation the other or contrary way, the electromagnetic wave emitter 3 can be omitted. Specifically, firstly, the output voltage of the electromagnetic wave oscillator 5 is prepared to set high such that the discharge device 2 surely performs to discharge. Then, after the fuel is ignited, the output voltage of the electromagnetic wave oscillator 5 is dare to be lower, it is controlled such that the microwave is emitted from the distal end of the discharge electrode 26, and thereby, the flame can be expanded. Accordingly, the electromagnetic wave emitter 3 itself can be omitted.

Moreover, with the ignition unit 1C of the third embodiment and etc., microwave input toward the discharge device 2 and the electromagnetic wave emitter 3 is assumed on performance from separate channels of the electromagnetic wave oscillator 5, but the microwave may be supplied from same channel to the ignition unit 1C, that is, a microwave distributer is provided inside the ignition unit 1C, and the microwave may be supplied to the discharge device 2 and the electromagnetic wave emitter 3 from the microwave distributer.

The above-mentioned antennas 60 may be used for the purpose besides the flame expansion. For example, the antennas 60 may be positioned in the vicinity of exhaust port, and they may function as transmission antennas not serving as receiving antennas so as to utilize for the exhaust gas treatment. In this case, as illustrated in FIG. 15(b), a cavity space 64 may be provided on a rectangular substrate 61 in order that the exhaust gas can be circulated.

### EXPLANATION OF REFERENCES

1. Ignition Unit
2. Discharge Device
3. Electromagnetic Wave Emitter
4. Casing
5. Electromagnetic Wave Oscillator
6. Controller
10. Ignition System

1. An ignition unit comprising:
a discharge device comprising a booster and a discharger provided at an output side of the booster, the booster having a resonance structure configured to boost an electromagnetic wave inputted from an electromagnetic wave oscillator so as to cause a discharge from the discharger; and
an electromagnetic wave emitter configured to emit an electromagnetic wave inputted from the electromagnetic wave oscillator.

2. The ignition unit according to claim 1, further comprising a housing part,
wherein the housing part comprises a first hole into which the discharge device is inserted and a second hole into which the electromagnetic wave emitter is inserted such that the housing part houses therein both the discharge device and the electromagnetic wave emitter, and
wherein the housing part can be inserted into a single hole of a cylinder head of an internal combustion engine.

3. The ignition unit according to claim 1,
wherein the discharge device comprises a center electrode, a cylindrical conductor surrounding the center electrode, and a dielectric provided between an inner wall of the cylindrical conductor and the center electrode,
wherein the center electrode comprises a first part and a second part, the first part being configured to receive the electromagnetic wave from the electromagnetic wave oscillator, the second part having a distal end and being capacity-coupled with the first part, and
wherein the discharge is caused between the distal end of the second part and the inner wall of the cylindrical conductor.

4. An ignition system comprising:
an electromagnetic wave oscillator configured to oscillate and output an electromagnetic wave;
a discharge device comprising a booster and a discharger provided at an output side of the booster, the booster having a resonance structure configured to boost the electromagnetic wave inputted from the electromagnetic wave oscillator so as to cause a discharge from the discharger;
an electromagnetic wave emitter electrically connected to the electromagnetic wave oscillator and configured to emit the electromagnetic wave inputted from the electromagnetic wave oscillator; and
a controller configured to control the discharge device and the electromagnetic wave emitter and to perform a first operation to ignite fuel in a combustion chamber by setting the electromagnetic wave emitter to off for output and setting the discharge device to on for output, and then perform a second operation to expand an ignited flame by setting the electromagnetic wave emitter to on for output.

5. The ignition system according to claim 4,
wherein the controller performs only the first operation during a first operation condition under which a low load is detected, and
wherein the controller alternately repeats the first operation and the second operation during a second operation condition under which a high load is detected.

6. An internal combustion engine comprising:
the ignition system according to claim 4;
a piston; and
an antenna positioned on a top surface of the piston and configured to receive the electromagnetic wave from the electromagnetic wave emitter; and
wherein the antenna is constituted by a substrate made of a ceramic material and a conductor formed on the substrate.

7. An internal combustion engine comprising:
the ignition system according to claim 4;
a cylinder head; and
an antenna positioned on a bottom surface of the cylinder head and configured to receive the electromagnetic wave from the electromagnetic wave emitter; and
wherein the antenna is constituted by a substrate made of a ceramic material and a conductor formed on the substrate.
